(19) United States
(12) Patent Application Publication
(10) Pub. No.: US 2013/0058603 A1
(43) Pub. Date: Mar. 7, 2013

(54) SPINDLE MOTOR

(71) Applicant: Jin San Kim, Gyunggi-do (KR)

(72) Inventor: Jin San Kim, Gyunggi-do (KR)

(73) Assignee: Samsung Electro-Mechanics Co., Ltd., Suwon (KR)

(21) Appl. No.: 13/402,256

(22) Filed: Feb. 22, 2012

(30) Foreign Application Priority Data
Sep. 7, 2011 (KR) 10-2011-0090675

(51) Int. Cl. F16C 17/04

(52) U.S. Cl. 384/241

(57) ABSTRACT

There is provided a spindle motor including: a hub moving together with a shaft; a sleeve supporting the shaft with oil; a stopper provided in the hub to thereby prevent excessive floating of the shaft; and oil storage parts formed on the stopper so as to be in communication with the outside, providing a storage space for the oil, and allowing an oil interface to be formed therein.

### CROSS-REFERENCE TO RELATED APPLICATIONS

This application claims the priority of Korean Patent Application No. 10-2011-0090675 filed on Sep. 7, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor capable of being used in a hard disk drive (HDD) rotating a recording disk.

2. Description of the Related Art

A hard disk drive (HDD), an information storage device, reads data stored on a disk or writes data to a disk using a read/write head.

The hard disk drive requires a disk driving device capable of driving the disk. As the disk driving device, a spindle motor is used.

In the spindle motor, a fluid dynamic bearing is in common use. A shaft, a rotating member of the fluid dynamic bearing, and a sleeve, a fixed member thereof, include oil interposed therebetween, such that the shaft is supported by fluid pressure generated in the oil.

When a temperature of the spindle motor according to the related art rises, oil may deviate from a normal oil interface due to oil expansion, which causes oil leakage, and accordingly, spindle motor performance may be deteriorated.

Particularly, in the case that an external impact is applied to the spindle motor, oil leakage may cause serious problems therein, thereby reducing a lifespan thereof.

Further, in the spindle motor according to the related art, a stopper is disposed under the shaft in order to prevent excessive floating of the rotating member. A height of the sleeve in an axial direction may be relatively reduced due to space occupied by the stopper, such that rigidity of the bearing may be weakened.

Furthermore, in the case that an external impact is applied to the spindle motor, it may be difficult to maintain rigidity of a hub in the structure of the stopper according to the related art, such that the hub may often be separated from the shaft.

Therefore, research into technology capable of preventing an oil shortage phenomenon due to oil leakage even in the case that a motor temperature rises or an external impact is applied thereto, improving rigidity of a bearing, and preventing separation of a hub due to the application of an external impact has been urgently demanded.

### SUMMARY OF THE INVENTION

An aspect of the present invention provides a spindle motor capable of preventing a hub from being separated from a shaft due to an external impact, maximizing an amount of stored oil, and preventing an oil shortage phenomenon due to oil leakage, to improve bearing rigidity.

According to an aspect of the present invention, there is provided a spindle motor including: a hub moving together with a shaft; a sleeve supporting the shaft with oil; a stopper provided in the hub to thereby prevent excessive floating of the shaft; and oil storage parts formed on the stopper so as to be in communication with the outside, providing a storage space for the oil, and allowing an oil interface to be formed therein.

The oil storage parts may allow upper and lower surfaces of the stopper to be in communication with each other.

The oil storage parts may be spaced apart from each other in a circumferential direction.

The oil storage parts may be formed through an outer peripheral surface of the stopper being stepped.

The oil storage parts may be formed to be symmetrical to each other, based on a center or rotation of the shaft.

The stopper may be a sintered body in which the oil is impregnated.

The stopper may be continuously formed along an outer peripheral surface of the sleeve.

The oil interface may be formed between an inner peripheral surface of the stopper and an outer peripheral surface of the sleeve.

The stopper may contact the sleeve to thereby prevent excessive floating of the shaft.

The hub may include a wall part extended downwardly therefrom in an axial direction, the stopper may be fixed to the wall part, and the oil interface may be formed between the oil storage parts and the wall part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is a schematic cut-away perspective view showing a sleeve provided in the spindle motor according to the embodiment of the present invention;

FIG. 3 is a schematic exploded cut-away perspective view showing a coupling relationship between a hub and a stopper provided in the spindle motor according to the embodiment of the present invention; and

FIG. 4 is a schematic perspective view showing a modified example of the stopper provided in the spindle motor according to the embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

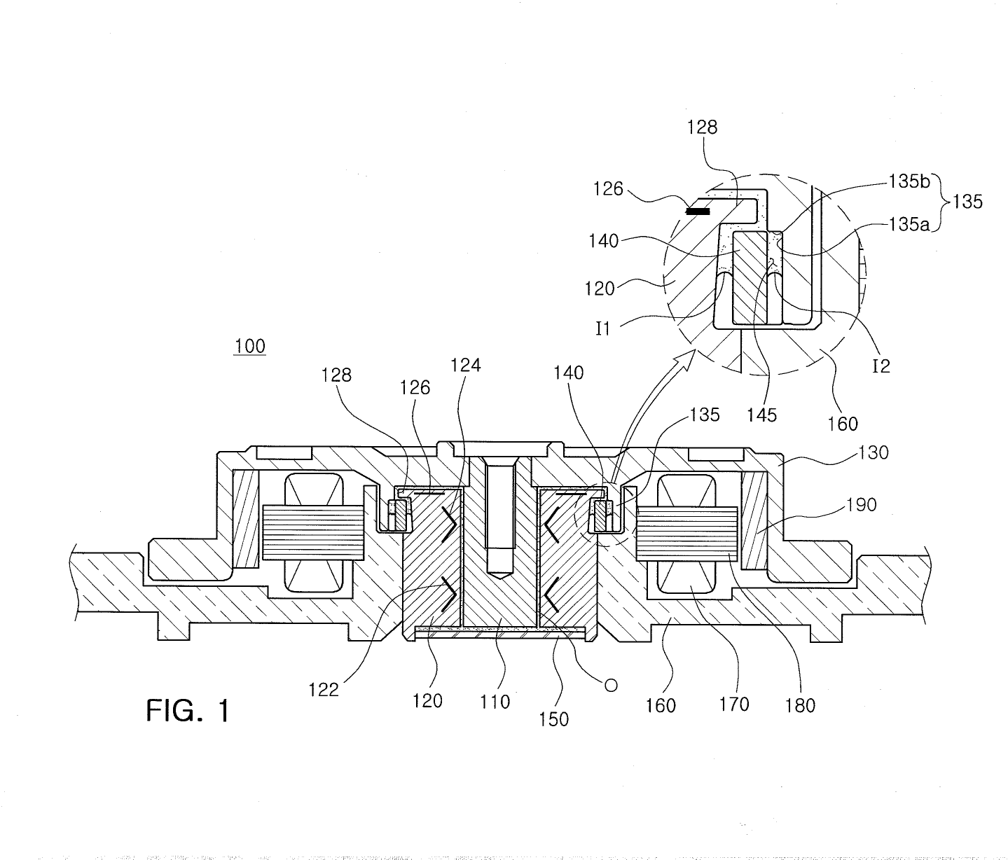

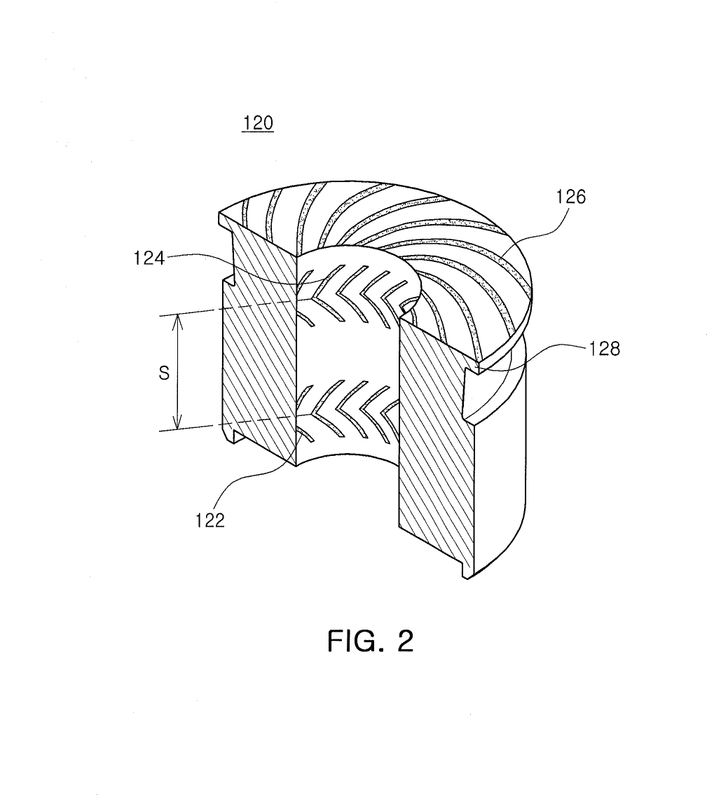

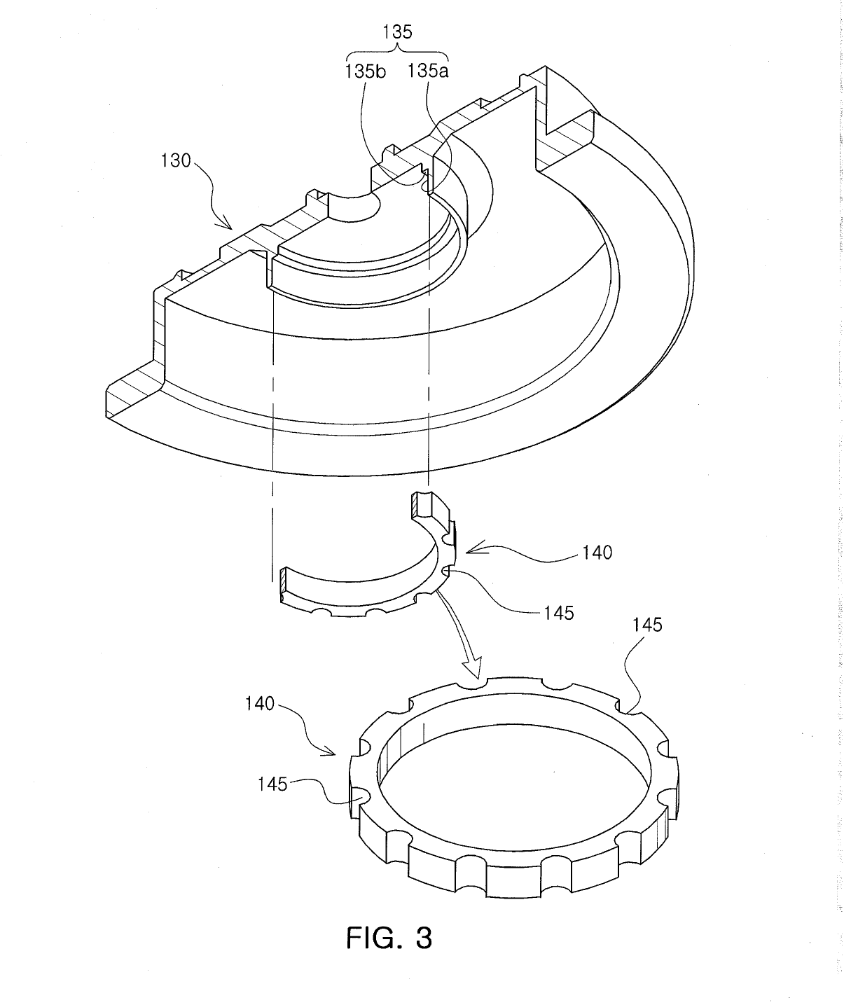

FIG. 1 is a schematic cross-sectional view showing a spindle motor according to an embodiment of the present invention; FIG. 2 is a schematic cut-away perspective view showing a sleeve provided in the spindle motor according to the embodiment of the present invention; and FIG. 3 is a schematic exploded cut-away perspective view showing a coupling relationship between a hub and a stopper provided in the spindle motor according to the embodiment of the present invention.

Referring to FIGS. 1 through 3, a spindle motor 100 according to an embodiment of the present invention may include a hub 130, which is a rotating member, a sleeve 120, which is a fixed member, and a stopper 140 having an oil storage part 145 formed thereon.

Terms with respect to directions will be first defined. As viewed in FIG. 1, an axial direction refers to a vertical direction based on the shaft 110, and an outer radial direction and an inner radial direction refers to a direction towards an outer edge of the hub 130 based on the shaft 110 and a direction towards the center of the shaft 110 based on the outer edge of the hub 130, respectively.

In addition, a circumferential direction refers to a direction in which the hub 130 and the shaft 110 rotate along an outer peripheral surface of the shaft 110.

The hub 130 may be a rotating structure moving together with the shaft 110 and rotatably provided with respect to fixed members including the base 160.

Here, the hub 130 may include an annular ring shaped magnet 190 provided on an inner peripheral surface thereof. The magnet 190 corresponds to a core 180 coupled to a base 160 and having a coil 170 wound thereon while having a predetermined interval therebetween.

The magnet 190 may provide rotational driving force of the spindle motor 100 according to the embodiment of the present invention. The rotational driving force may be generated by electromagnetic interaction between the magnet 190 and the coil 170 wound around the core 180.

The shaft 110 is a rotating member coupled to hub 130 to thereby rotate together with the hub 130. The shaft 110 may be supported by the sleeve 120.

Here, the sleeve 120 may support the shaft 110 such that an upper end of the shaft 110 protrudes upwardly in the axial direction and may be formed by forging Cu or Al or sintering a Cu—Fe based alloy powder or an SUS based power.

In addition, the sleeve 120 may include a shaft hole having the shaft 110 inserted thereinto so as to have a micro clearance therebetween, and the micro clearance may be filled with oil O to thereby stably support the shaft 110 by radial dynamic pressure through the oil O.

Here, the radial dynamic pressure through the oil O may be generated by upper and lower fluid dynamic pressure generating parts 124 and 122 formed as grooves in an inner peripheral surface of the sleeve 120. The upper and lower fluid dynamic pressure generating parts 124 and 122 may have a herringbone shape.

Although FIGS. 1 and 2 show that the upper and lower fluid dynamic pressure generating parts 124 and 122 have a herringbone shape, the upper and lower fluid dynamic pressure generating parts 124 and 122 are not limited to having the herringbone shape but may have a spiral shape or a helical shape.

Here, the upper and lower fluid dynamic pressure generating parts 124 and 122 are not limited to being formed in the inner peripheral surface of the sleeve 120 as described above but may also be formed in an outer peripheral surface of the shaft 110. In addition, the number of upper and lower fluid dynamic pressure generating parts 124 and 122 is also not limited.

In addition, the sleeve 120 may include a thrust dynamic pressure generating part 126 formed in an upper surface thereof so as to generate thrust dynamic pressure via the oil O. The rotating member including the shaft 110 may rotate in a state in which a predetermined floating force is secured by the thrust dynamic pressure generating part 126.

Here, the thrust dynamic pressure generating part 126 may be a groove having a herringbone shape, a spiral shape, or a helical shape, similar to the upper and lower fluid dynamic pressure generating parts 124 and 122. However, the thrust dynamic pressure generating part 126 is not limited to having the above-mentioned shape but may also have any shape as long as it may provide thrust dynamic pressure.

In addition, the thrust dynamic pressure generating part 126 is not limited to being formed in the upper surface of the sleeve 120 but may also be formed in one surface of the hub 130 corresponding to the upper surface of the sleeve 120.

Further, the sleeve 120 may include a base cover 150 coupled to a lower portion thereof so as to close the lower portion thereof. The motor 100 according to the embodiment of the present invention may be formed to have a full-fill structure by the base cover 150.

In addition, the sleeve 120 may have a catching part 128 protruding outwardly from an upper portion thereof in a radial direction. The catching part 128 may prevent excessive floating of the rotating member including the shaft 110 and the hub 130 when the rotating member floats while rotating.

That is, when the rotating member including the hub 130 is excessively floated, the catching part 128 contacts the stopper 140 coupled to the hub 130 to block the excessive floating of the rotating member, thereby preventing the rotating member from being separated from the fixed member including the sleeve 120.

Here, the hub 130 may include a wall part 135 disposed outside the sleeve 120 and protruding downwardly therefrom in the axial direction, and the wall part 135 may have the stopper 140 coupled thereto.

The wall part 135 may be continuously formed in the circumferential direction and include coupling parts 135a and 135b formed in a stepped inner peripheral surface thereof so as to be coupled to the stopper 140.

More specifically, the coupling parts 135a and 135b may include a first coupling part 135b to which an upper surface of the stopper 140 is coupled and a second coupling part 135a to which an outer peripheral surface of the stopper 140 is coupled.

Here, the stopper 140, coupled to the coupling parts 135a and 135b, may be a component preventing the excessive floating of the rotating member including the shaft 110 and the hub 130 as described above.

That is, the stopper 140 may be fixedly coupled to the coupling parts 135a and 135b of the wall part 135 formed in the hub 130 and contact the catching part 128 of the sleeve 120, whereby the excessive floating of the rotating member may be prevented.

Here, the stopper 140 may be continuously formed along the inner peripheral surface of the wall part 135 in the circumferential direction and prevent the rotating member including the shaft 110 and the hub 130 from being separated from the fixed member including the sleeve 120 and the base 160 due to an external impact.

In addition, due to the stopper 140, the separation of the hub 130 from the shaft 110 may also be prevented, since the stopper 140 is not fixed to the shaft 110.

That is, in the motor according to the related art, the stopper is coupled to a lower end of the shaft in order to prevent excessive floating of the rotating member. Specifically, when the rotating member is excessively floated, the stopper contacts a bottom surface of the sleeve, thereby preventing the excessive floating of the rotating member.

The stopper according to the related art, described above, has a structure in which it only contacts the sleeve, rather than the hub, when an external impact is applied thereto. Accordingly, the stopper may prevent the separation of the shaft, while it does not contribute to preventing the hub from being separated from the shaft.

However, the stopper 140 according to the embodiment of the present invention contacts the sleeve 120 in a state in which it is coupled to the coupling parts 135a and 135b of the hub 130, whereby the separation of the hub 130 from the shaft 110 as well as the separation of the shaft 110 due to an external impact may be prevented.

In addition, the structure of the stopper 140 according to the embodiment of the present invention increases a bearing span S, whereby the overall rigidity of the bearing may be increased.

Here, in describing the bearing span length S based on the spindle motor 100 according to the embodiment of the present invention, the bearing span length S refers to a distance between points at which the highest levels of pressure are generated by the upper and lower fluid dynamic pressure generating parts 124 and 122. As the distance is lengthened, the rotation of the shaft 110 may be stably supported.

In other words, when the distance between the points at which the highest levels of pressures are generated by the upper and lower fluid dynamic pressure generating parts 124 and 122 is lengthened, a distance between points supporting the shaft 110 is lengthened to improve the rigidity of the bearing, such that the rotation characteristics of the shaft 110 are improved.

Since the spindle motor according to the related art includes the stopper disposed in a lower portion thereof in the axial direction, a length of the sleeve in the axial direction may be relatively shortened, as compared to the case of a motor that does not include the stopper, due to space occupied by the stopper, such that the bearing span length may be necessarily shortened.

However, the spindle motor according to the embodiment of the present invention allows the stopper 140 to be disposed outside of the sleeve 120 such that the stopper may not occupy the space according to the related art, whereby the length of the sleeve 120 in the axial direction may be increased as compared to the spindle motor according to the related art.

Therefore, the bearing span length S is also increased, such that force supporting the rotating member including the shaft 110 and the hub 130 may be increased. As a result, the rigidity of the bearing may be improved.

In addition, the stopper 140 provided in the spindle motor 100 according to the embodiment of the present invention may include the oil storage part 145 formed thereon to be in communication with the outside, providing a storage space for the oil O, and allowing an oil interface I2 of the oil O to be formed therein.

More specifically, the oil storage part 145 may be formed by allowing the upper and lower surfaces of the stopper 140 to be in communication with each other and may be in communication with a clearance between the sleeve 120 and the hub 130 in which the oil O is filled.

Since the oil storage part 145 may be in communication with the outside, such that it may allow the clearance between the sleeve 120 and the hub 130 to be in communication with the outside.

Therefore, the oil storage parts 145 may be filled with the oil O, and the oil O contacts the outside, whereby the oil interface I2 may be formed.

Here, the oil interface I2 may be a secondary oil interface due to the oil storage part 145 in the spindle motor 100 according to the embodiment of the present invention. A primary oil interface I1 may be formed in a clearance between an inner peripheral surface of the stopper 140 and an outer peripheral surface of the sleeve 120.

That is, even when the oil storage part 145 is not provided, the oil interface I1 may be formed in the clearance between the inner peripheral surface of the stopper 140 and the outer peripheral surface of the sleeve 120, and the other oil interface I2 may be formed due to the oil storage part 145 in order to increase an amount of the stored oil O.

A plurality of oil storage parts 145 may be formed to be spaced apart from each other in the circumferential direction and may have constant cross-sectional area.

However, the cross-sectional area of the oil storage part 145 in the radial direction is not limited thereto, but may be increased or decreased.

In addition, the plurality of oil storage parts 145 spaced apart from each other may be formed to be symmetrical to each other based on the center of rotation, but is not necessarily limited thereto.

Here, the oil storage part 145 may be formed by allowing at least one portion of the outer peripheral surface of the stopper 140 to be stepped or allowing at least one portion of the outer peripheral surface of the stopper 140 to be recessed in the inner radial direction.

The oil storage part 145 increases a storage space for the oil O provided to the spindle motor 100 according to the embodiment of the present invention, whereby a shortage phenomenon of the oil (O) caused by leakage of the oil O that may occur due to a rise in temperature or an external impact may be significantly reduced.

That is, since the shortage phenomenon of the oil O provided to the spindle motor 100 according to the embodiment of the present invention may be prevented, solid friction between the sleeve 120 and the hub 130 due to the shortage of the oil O may be prevented.

As a result, abrasion and power consumption that may be caused due to the solid friction may be prevented, whereby the spindle motor 100 having enhanced performance and lifespan may be realized.

In the spindle motor 100 according to the embodiment of the present invention, the stopper 140 having the oil storage part 145 in order to maximize an amount of stored oil O may be a sintered body in which the oil O may be impregnated.

Here, the sintered body may be formed by pressing and molding a powder and then heating the powder, and may include micro pores.

Therefore, when the stopper 140 is formed as the sintered body, the oil O may be impregnated in the pores of the sintered body, such that an amount of stored oil O may be increased due to the pores.

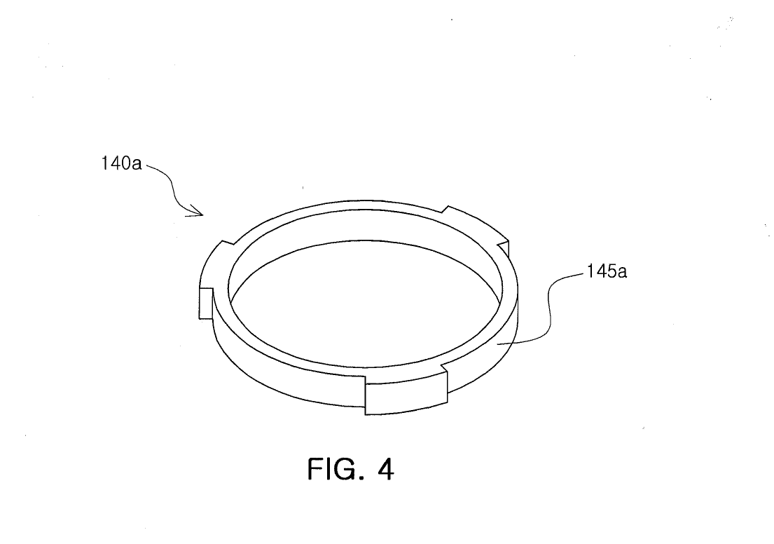

FIG. 4 is a schematic perspective view showing a modified example of the stopper provided in the spindle motor according to the embodiment of the present invention.

Referring to FIG. 4, a stopper 140a may include an oil storage part 145a. Due to the oil storage part 145a, an amount of oil O required for the spindle motor 100 according to the embodiment of the present invention may be maximized.

Here, the oil storage part 145a may be formed by allowing an outer peripheral surface of the stopper 140a to be stepped. In addition, a plurality of oil storage parts 145a may be formed to be spaced apart from each other and to be elongated in the circumferential direction.

In addition, the oil storage parts 145a may have a constant inward radial direction width along the outer peripheral surface of the stopper 140a in the circumferential direction, and have a constant interval therebetween.

That is, the oil storage parts 145a may be formed to be symmetrical to each other based on the center of rotation and allow upper and lower surfaces of the stopper 140a to be in communication with each other.

In addition, the stopper 140a having the oil storage part 145a in order to increase an amount of stored oil O may be a sintered body in which the oil O may be impregnated.

Here, a length of the oil storage part 145a in the circumferential direction and a width thereof in the radial direction are not limited but may be variously changed according to the intention of a designer with regard to an amount of stored oil O.

As set forth above, in the spindle motor 100 according to the embodiments of the present invention, the amount of stored oil O, provided to the fluid dynamic bearing, is increased due to the stopper 140 having the oil storage part 145 or 145a formed thereon, whereby the shortage phenomenon of the oil O caused by the leakage of the oil O that may occur due to a rise in temperature or an external impact may be significantly reduced.

In addition, the separation of the hub 130 from the shaft 110 due to an external impact may be prevented, and the bearing span is increased, whereby the rigidity of the bearing may be maximized.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a hub moving together with a shaft;
a sleeve supporting the shaft with oil;
a stopper provided in the hub to thereby prevent excessive floating of the shaft; and
oil storage parts formed on the stopper so as to be in communication with the outside, providing a storage space for the oil, and allowing an oil interface to be formed therein.

2. The spindle motor of claim 1, wherein the oil storage parts allow upper and lower surfaces of the stopper to be in communication with each other.

3. The spindle motor of claim 1, wherein the oil storage parts are spaced apart from each other in a circumferential direction.

4. The spindle motor of claim 1, wherein the oil storage parts are formed through an outer peripheral surface of the stopper being stepped.

5. The spindle motor of claim 1, wherein the oil storage parts are formed to be symmetrical to each other based on a center of rotation of the shaft.

6. The spindle motor of claim 1, wherein the stopper is a sintered body in which the oil is impregnated.

7. The spindle motor of claim 1, wherein the stopper is continuously formed along an outer peripheral surface of the sleeve.

8. The spindle motor of claim 1, wherein the oil interface is formed between an inner peripheral surface of the stopper and an outer peripheral surface of the sleeve.

9. The spindle motor of claim 1, wherein the stopper contacts the sleeve to thereby prevent excessive floating of the shaft.

10. The spindle motor of claim 1, wherein the hub includes a wall part extended downwardly therefrom in an axial direction, and
the stopper is fixed to the wall part and the oil interface is formed between the oil storage parts and the wall part.
